(19) United States
(12) Patent Application Publication
(10) Pub. No.: US 2005/0050233 A1
(43) Pub. Date: Mar. 3, 2005

(54) Parallel processing apparatus

(75) Inventors: Kenichiro Anjo, Kanagawa (JP); Masato Motomura, Kanagawa (JP)

Correspondence Address: FOLEY AND LARDNER;SUITE 500, 3000 K STREET NW, WASHINGTON, DC, 20007, US

(73) Assignee: NEC Electronics Corporation

(21) Appl. No.: 10/924,373

(22) Filed: Aug. 24, 2004

(30) Foreign Application Priority Data
Aug. 28, 2003 (JP) 2003-304755

(51) Int. Cl. G06F 3/00

(52) U.S. Cl. 710/1

(57) ABSTRACT

When combinations of a plurality of data transmission ports with a plurality of types of transfer IDs are simply registered for each of combinations of a plurality of data reception ports and a plurality of types of transfer IDs beforehand in a map table of a transfer intermediation circuit, transfer data received at a data reception port of the transfer intermediation circuit together with a transfer ID can be transmitted from a predetermined data transmission port to a transfer intermediation circuit or a variable processing circuit at the next stage together with a transfer ID of the next stage, so that data can be reliably transferred among a plurality of variable processing circuits in a simple configuration.

### BACKGROUND OF THE INVENTION

1. Field of the Invention

The present invention relates to a parallel processing apparatus which has a plurality of variable processing circuits arranged in a predetermined layout together with a plurality of transfer intermediation circuits, wherein each of the variable processing circuits variably executes a variety of processing in accordance with object codes, and the transfer intermediation circuits intermediate mutual data transfers between the variable processing circuits.

2. Description of the Related Art

Currently, processor units capable of flexibly executing a variety of data processing, so-called CPU (Central Processing Unit) and MPU (Micro Processor Unit), have been brought into practical use.

In a data processing system which utilizes such a processor unit, a variety of object codes which describe a plurality of operation instructions, and a variety of data to be processed are stored in a memory device, such that the processor unit orderly reads the operation instructions and data to be processed from the memory device to sequentially execute a plurality of data processing.

Thus, a variety of data processing can be carried out by a single processor unit, in which case a plurality of data processing must be sequentially executed in order, and the processor unit must read associated operation instructions from the memory device for each sequential processing, making it difficult to execute complicated data processing at high speeds.

On the other hand, when data processing to be executed is limited to one type, a logic circuit may be formed in hardware to execute this type of data processing, thereby eliminating the need for reading a plurality of operation instructions in order from a memory device and sequentially executing a plurality of data processing in order, as otherwise done by a processor unit. Consequently, the logic circuit can rapidly execute complicated data processing, but, as a matter of course, it can only support a single type of data processing.

In other words, while a data processing system which can freely switch object codes is capable of executing a variety of data processing, this system encounters difficulties in rapidly executing data processing because its hardware configuration is fixed. On the other hand, a hardware-based logic circuit is capable of rapidly executing data processing, but can execute only one type of data processing because its object codes cannot be changed.

To solve the problems as mentioned above, the applicant has invented a parallel processing apparatus which is one type of processor unit that changes the hardware configuration corresponding to software. In this parallel processing apparatus, multiple small-scaled data processing circuits and wire switching circuits of are arranged in a matrix, and a state management circuit is added in parallel with the matrix circuit.

A plurality of data processing circuits individually execute data processing corresponding to operation instructions which are set individually for the respective data processing circuits, while a plurality of wire switching circuits individually switch connection relationships of the plurality of data processing circuits corresponding to individually set operation instructions.

Stated another way, the parallel processing apparatus can be varied in hardware configuration by switching operation instructions issued to the plurality of data processing circuits and the plurality of wire switching circuits, and can therefore execute a variety of data processing. In addition, since the multiple small-scaled data processing circuits parallelly execute simple data processing in hardware, the parallel processing apparatus is capable of rapidly executing the data processing.

Then, since the state management circuit sequentially switches contexts, each comprised of operation instructions issued to the plurality of data processing circuits and the plurality of wire switching circuits as described above, from one operation cycle to another in accordance with object codes, the parallel processing apparatus can continuously execute parallel processing in accordance with the object codes (for example, see JP-2000-138579-A, JP-2000-224025-A, JP-2000-232354-A, JP-2000-232162-A, JP-2003-76668-A, JP-2003-99409, “Introduction to the Configurable, Highly Parallel Computer”, written by Lawrence Synder, Purdue University, “IEEE Computer”, vol. 15, No.1, pp47-57, January 1982, and “Interconnection networks enable fine-grain dynamic multi-tasking on FPGAs” (retrieved from URL:http://www.imec.be/design/pdf/reconfig/FPL_{—}02_interconnection.pdf, on Aug. 13, 2003),

Currently, in FPGA (Field Programmable Gate Array) which is used in practice as a parallel processing apparatus as described above, multiple switching elements and data wires are required in wire switching circuits for flexibly connecting multiple data processing circuits arranged in matrix, so that the wire switching circuits will be excessively increased in circuit scale as a larger number of data processing circuits are mounted in the FPGA.

Further, even if source codes are designed to be organized into a plurality of tasks, these tasks are combined into a single task for which the data processing circuits are determined in configuration and connection, so that the FPGA requires an immense computing time for generating object codes for the thus configured and connected data processing circuits. When a plurality of tasks are built in a plurality of regions as data pass circuits, wires of another task may be formed in a region in which a data pass circuit for a particular task has been built, so that the FPGA encounters difficulties in flexibly changing a data pass circuit for a task in each region.

Further, since the longest data transfer path constitutes a critical path, it is difficult to successfully increase the speed of data processing. This problem could be solved by adding a holder circuit such as a flip-flop, but the resulting FPGA would suffer from an increased circuit scale and a complicated circuit configuration.

To solve the problem as mentioned above, “Interconnection networks enable fine-grain dynamic multi-tasking on FPGAs” discloses dividing FPGA into a plurality of processing regions, and parallelly processing a plurality of tasks in the respective processing regions. In addition, the plurality of processing regions are interconnected through a network router which mutually transfers data for a plurality of tasks among the processing regions.

More specifically, when transfer data is delivered to the network router from a processing region, a header which describes the address of the destination, a data length, and the like is generated and added to the transfer data. Such a header must also describe ancillary information for identifying transfer data on a task. The header must describe at least the destination, the data length of transfer data, and an identifier of transfer data at the destination.

Since the network router transfers data to a predetermined processing region in accordance with the data contents of the header, one and the same data wire can be utilized in a time division mode, thus eliminating multiple switching elements and data wires. However, the foregoing strategy forces each processing region to generate the header which describes the address of the destination, data length, and the like. The generation of the header involves complicated data processing, and must be incorporated in each task.

The header also describes the data length of transfer data, so that when the transfer data is real time data, for example, audio, image or the like, the transfer data must be stored until the data length is found. For this reason, each processing region requires a storage circuit having a sufficient data capacity, thus causing an increase in circuit scale and a delay in transfer timing of transfer data.

Since the header is long because of a variety of data described therein, a transfer efficiency is relatively degraded when short data is transferred. When long data is transferred for preventing the degraded transfer efficiency, the total data length of the header and transfer data can be excessively long. Thus, a particular header and transfer data can occupy a plurality of network routers and data wires to cause dead lock.

While the dead lock can be prevented by additionally connecting a FIFO (First In First Out) memory to each of internal wires of the network router to virtually provide a plurality of transfer paths, this solution will result in an increased circuit scale and a complicated circuit configuration of the network router.

In addition, in the parallel processing apparatus as described above, since there is no limitations to the type of data transferred through a transfer route which directly connects two network routers to each other, no prediction can be made as to how many types of data are transferred through a certain transfer route. Therefore, when the parallel processing apparatus is actually operated, the inability to predict possible internal congestion could result in a failure in ensuring the minimum performance.

### SUMMARY OF THE INVENTION

The present invention has been made in view of the problems as mentioned above, and it is an object of the invention to provide a parallel processing apparatus which is capable of satisfactorily executing a data transfer in a simple configuration.

The parallel processing apparatus of the present invention has a plurality of variable processing circuits and a plurality of transfer intermediation circuits. The plurality of variable processing circuits and the plurality of transfer intermediation circuits are arranged in a predetermined layout. Each of the variable processing circuits has processing executing means and transfer assigning means, and variably executes each of a variety of processing in accordance with object codes. The transfer intermediation circuit has a plurality of data reception ports, a plurality of data transmission ports, route storing means, and transfer control means, and intermediates mutual data transfers among the variable processing circuits.

The processing executing means of the variable processing circuit arbitrarily receives and delivers transfer data by a variety of processing, while the transfer assigning means assigns one of a plurality of types of transfer IDs to transfer data delivered to a transfer intermediation circuit corresponding to a variable processing circuit which is the final destination.

The plurality of data reception ports of the transfer intermediation circuit each receive transfer data together with a transfer ID from surrounding variable processing circuits or from a transfer intermediation circuit. The plurality of data transmission ports each transmit transfer data together with a transfer ID to surrounding variable processing circuits or to a transfer intermediation circuit. The route storing means variably stores combinations of the plurality of data transmission ports with the plurality of types of transfer IDs for each of combinations of the plurality of data reception ports with the plurality of types of transfer IDs. The transfer control means transmits transfer data received at a data reception port together with a transfer ID to a predetermined data transmission port together with a transfer ID at the next stage in accordance with data stored in the route storage means.

Thus, when combinations of the plurality of data transmission ports with the plurality of types of transfer IDs are simply registered for each of combinations of the plurality of data reception ports and the plurality of types of transfer IDs beforehand in a map table of the transfer intermediation circuit, transfer data received at a data reception port of the transfer intermediation circuit together with a transfer ID. can be transmitted from a predetermined data transmission port to a transfer intermediation circuit or a variable processing circuit at the next stage together with a transfer ID of the next stage

A variety of means, referred to in the present invention, only need to be formed to provide their functions, and can be implemented, for example, by dedicated hardware capable of performing predetermined functions; a data processing apparatus which is provided with predetermined functions by a computer program, predetermined functions provided by a data processing apparatus by a computer program, a combination of these, and the like.

Also, a variety of means, referred to in the present invention, need not be always individually independent entities, but a plurality of means can be formed into a single member, certain means can be part of another means, part of certain means can overlap part of another means, and the like.

Further, while directions such as front, back, left, right, up and down are referred to in the present invention, they are defined for convenience of simply describing a relative relationship of directions, and do not limit directions during manufacturing or during use when the present invention is implemented.

Also, the “transfer ID,” referred to in the present invention, is only required to be digital data which is locally defined by each of the transfer intermediation circuits and variable processing circuits for identifying transfer data at the transfer intermediation circuits and variable processing circuits positioned on a transfer route. For example, the transfer ID can be set in two bits if there are four transfer routes.

Further, “assignment of a transfer ID to transfer data,” referred to in the present invention, is not limited to externally adding a transfer ID to transfer data, but can include internally inserting a transfer ID as part of the transfer data. In this event, a transfer ID can be changed by a transfer intermediation circuit by partially or fully rewriting the transfer data.

In the parallel processing apparatus of the present invention, when combinations of the plurality of data transmission ports with the plurality of types of transfer IDs are simply registered for each of combinations of the plurality of data reception ports and the plurality of types of transfer IDs beforehand in the route storing means of the transfer intermediation circuit, transfer data received at a data reception port of the transfer intermediation circuit together with a transfer ID can be transmitted from a predetermined data transmission port to a transfer intermediation circuit or a variable processing circuit at the next stage together with a transfer ID of the next stage, so that data can be reliably transferred among a plurality of variable processing circuits in a simple configuration. In addition, since the transfer intermediation circuit limits the type of transfer data, minimum performance can be ensured for the parallel processing apparatus.

The above and other objects, features, and advantages of the present invention will become apparent from the following description with reference to the accompanying drawings, which illustrate examples of the present invention.

### BRIEF DESCRIPTION OF THE DRAWINGS

FIGS. 1A, 1B are schematic diagrams representing a data transfer performed by an array processor which is one embodiment of a parallel processing apparatus according to the present invention;

FIG. 2 is a plan view illustrating the physical layout of the array processor;

FIGS. 3A, 3B are block diagrams each illustrating the physical configuration of a main portion of the array processor;

FIG. 4 is a schematic diagram illustrating how a variety of signals are delivered from an element area which comprises a variable processing circuit;

FIG. 5 is a schematic diagram illustrating how the element area receives a variety of signals;

FIG. 6 is a block diagram illustrating the internal configuration of a transfer intermediation circuit; and

FIGS. 7A, 7B, 7C are schematic diagrams each illustrating an exemplary modification to the output of the element area for delivering a variety of signals.

### DETAILED DESCRIPTION OF THE PREFERRED EMBODIMENTS

[Configuration of Embodiment]

Assume in the following that for simplifying the description, the horizontal direction is defined to be a row direction, while the vertical direction is defined to be a column direction in the drawings, and each row is arranged in the column direction, while each column is arranged in the row direction.

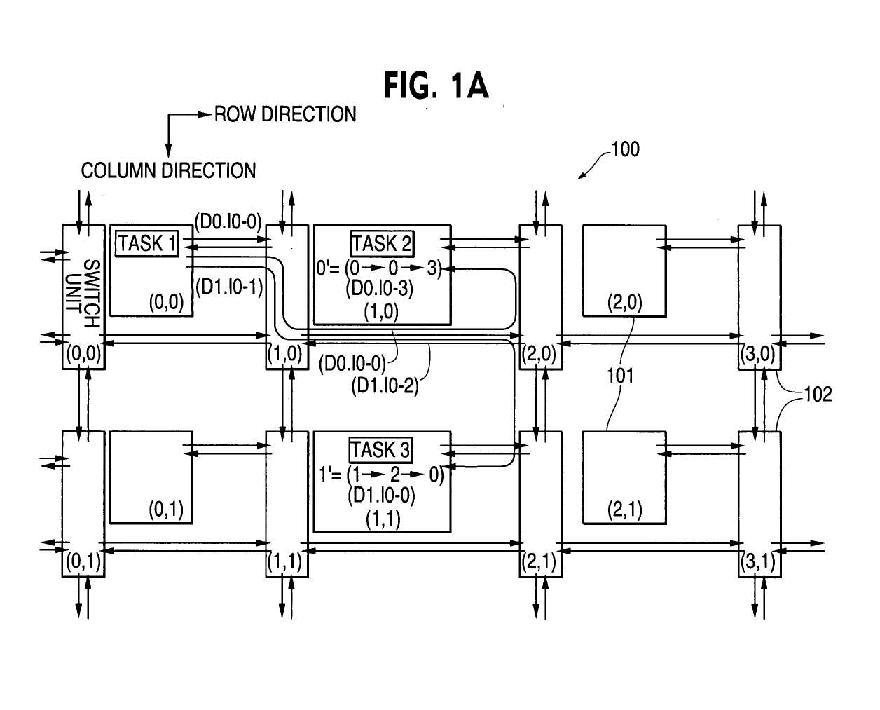

FIGS. 1A, 1B are schematic diagrams representing a data transfer performed by an array processor which is one embodiment of a parallel processing apparatus according to the present invention;

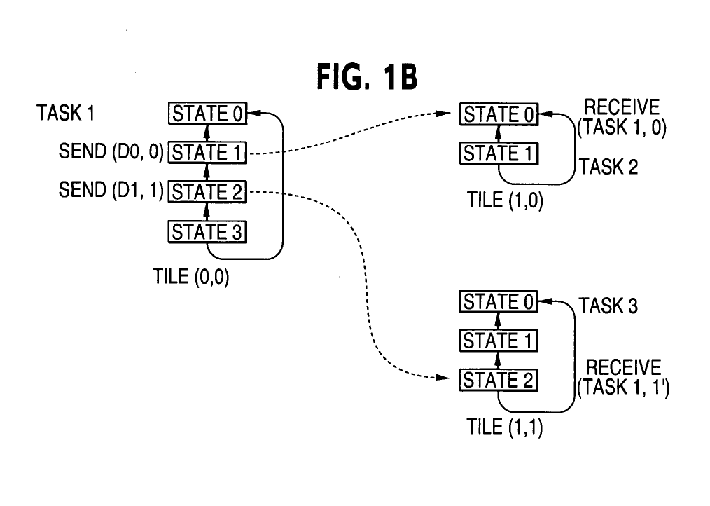

FIG. 2 is a plan view illustrating the physical layout of the array processor.

First, as illustrated in FIG. 2, array processor 100, which embodies a parallel processing apparatus according to one embodiment of the present invention, comprises a plurality of element areas 101, which represent variable processing circuits, arranged in a matrix, and transfer intermediation circuits 102 each mounted adjacent to each of element areas 101 in the row direction.

Element area 101 variably executes each of variety of processing in accordance with object codes, and transfer intermediation circuit 102 intermediates a data transfer between element areas 101. In array processor 100 of this embodiment, element areas 101 and transfer intermediation circuits 102 are arranged, for example, in a matrix having four rows and four columns, with single configuration management circuit 103 mounted halfway between the second and third rows.

A plurality of element areas 101 each comprise single state management circuit 105, a plurality of processor elements 106 which represent data processing circuits, and state management circuit 105 mounted halfway between the second and third rows of processor elements 106 arranged, for example, in a matrix of four rows and four columns.

State management circuit 105 controls the operation of processor elements 106 together with switch element 108. In array processor 100 of this embodiment, state management circuit 105 is simply connected to processor elements in each element area 101, so that state management circuit 105 merely manages the states of processor elements 106 connected thereto.

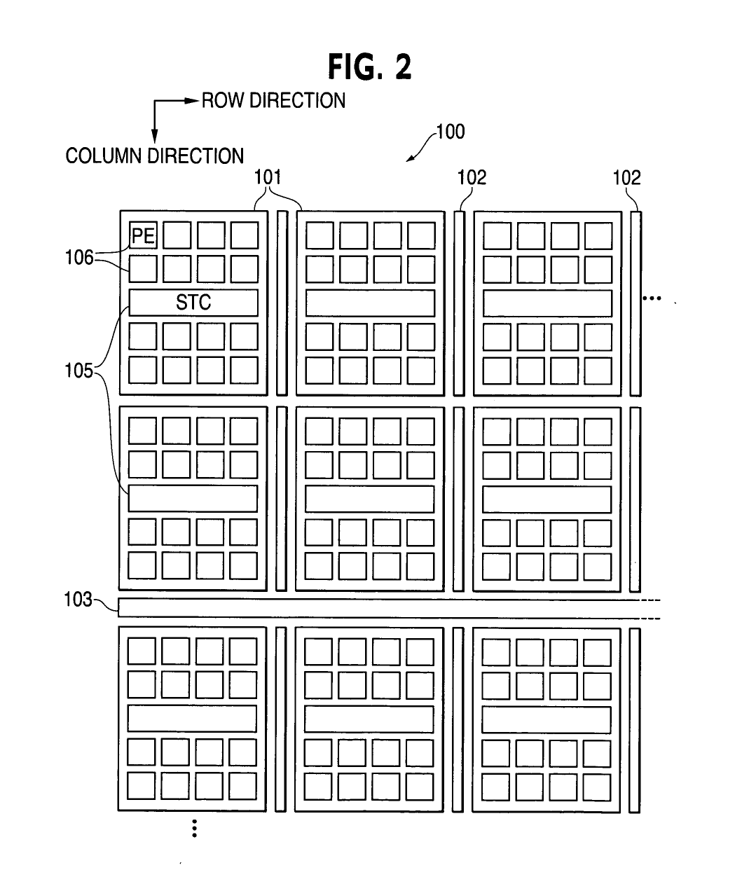

As illustrated in FIG. 3A, in element area 101, each of a plurality of processor elements 106 arranged in a matrix is connected to adjacent switch element 108, while a plurality of switch elements 108 arranged in a matrix are connected through multiple mb (m-bit) buses 109 and multiple nb (n-bit) buses 110 to form a matrix connection.

As illustrated in FIG. 3B, each processor element 106 comprises memory control circuit 111, instruction memory 112, instruction decoder 113, mb register file 115, nb register file 116, mb ALU (Arithmetic and Logical Unit) 117, nb ALU 118, internal variable wires (not shown), and the like. Each switch element 108 comprises bus connector 121, input control circuit 122, output control circuit 123, and the like.

Also, in array processor 100 of this embodiment, object codes, supplied from the outside, have set therein operation instructions for multiple processor elements 106 and multiple switching elements 108 of element area 101 as sequentially switching contexts. The object codes also have set therein operation instructions for state management circuit 105, which switches the contexts every operation cycle, as a sequentially switching operating states.

To support the object codes, state management circuit 105 stores operation instructions for itself, as mentioned above, and a transition rule for sequentially changing from one to another of a plurality of operating states. State management circuit 105 sequentially changes the operating states in accordance with the transition rule, and generates an instruction pointer of processor element 106 and switch element 108 with an operation instruction.

As illustrated in FIG. 3B, switch element 108 shares instruction memory 112 of adjacent processor element 106, so that state management circuit 105 supplies the generated instruction pointer of processor element 106 and switch element 108 to instruction memory 112 of corresponding processor element 106.

Since instruction memory 112 stores a plurality of operation instructions for processor element 106 and switch element 108, the operation instructions for processor element 106 and switch element 108 are specified by a single instruction pointer supplied from state management circuit 105.

Instruction decoder 113 decodes an operation instruction specified. by an instruction pointer to control the operation of switch element 108, internal variable wires, mb ALU 117, nb ALU 118, and the like.

Mb bus 109 transfers “8-bit” processed data, where 8-bit is represented by mb, while nb. bus 110 transfers “1-bit” processed data, where 1-bit is represented by nb, so that switch element 108 controls connection relationships of multiple processor elements 106 through mb bus 109 and nb bus 110 in accordance with the operation control conducted by instruction decoder 113.

More specifically, switch element 108 has bus connector 121 which communicates with mb buses 109 and nb buses 110 in four directions, and switch element 108 controls the mutual connection relationships of a plurality. of mb buses 109 thus in communication therewith, and the mutual connection relationships of a plurality of nb buses 110 in communication therewith.

For this control operation, in array processor 100, state management circuit 105 sequentially switches contexts of processor elements 106 for each of a plurality of element areas 101 in one operation cycle to another in response to object codes supplied from the outside, and at each stage, multiple processor elements 106 parallelly operate for individually configurable data processing.

As illustrated in FIG. 3B, input control circuit 122 controls a connection relationship involved in application of data from mb bus 109 to mb register file 115 and mb ALU 117, and a connection relationship involved in application of data from nb bus 110 to nb register file 116 and nb ALU 118.

Output control circuit 123 controls a connection relationship involved in delivery of data from mb register file 115 and mb ALU 117, and a connection relationship involved in delivery of data from nb register file 116 and nb ALU 118 to nb bus 110.

The internal variable wires of processor element 106 control a connection relationship between mb register file 115 and mb ALU 117 and a connection relationship between nb register file 116 and nb ALU 118 within processor element 106 in accordance with the control operation of instruction decoder 113.

Mb register file 115 temporarily holds mb processed data applied thereto from mb bus 109 and the like, and delivers the mb processed data to nb ALU 117 and the like in accordance with the connection relationship controlled by the internal variable wires. Nb register file 116 temporarily holds nb processed data applied thereto from nb bus 110 and the like, and delivers the nb processed data to nb ALU 118 and the like in accordance with the connection relationship controlled by the internal variable wires.

Mb ALU 117 executes data processing in accordance with the operation control of instruction decoder 113 with the mb processed data, while nb ALU 118 executes data processing in accordance with the control operation of instruction decoder 113 with the nb processed data, so that m-bit and/or n-bit data is processed as appropriate corresponding to the number of bits of processed data.

Also, as illustrated in FIG. 1A, in array processor 100 of this embodiment, each of a plurality of element areas 101 arranged in a matrix is connected to adjacent transfer intermediation circuit 120, and a plurality of transfer intermediation circuits 102 arranged in a matrix are connected to form a matrix connection.

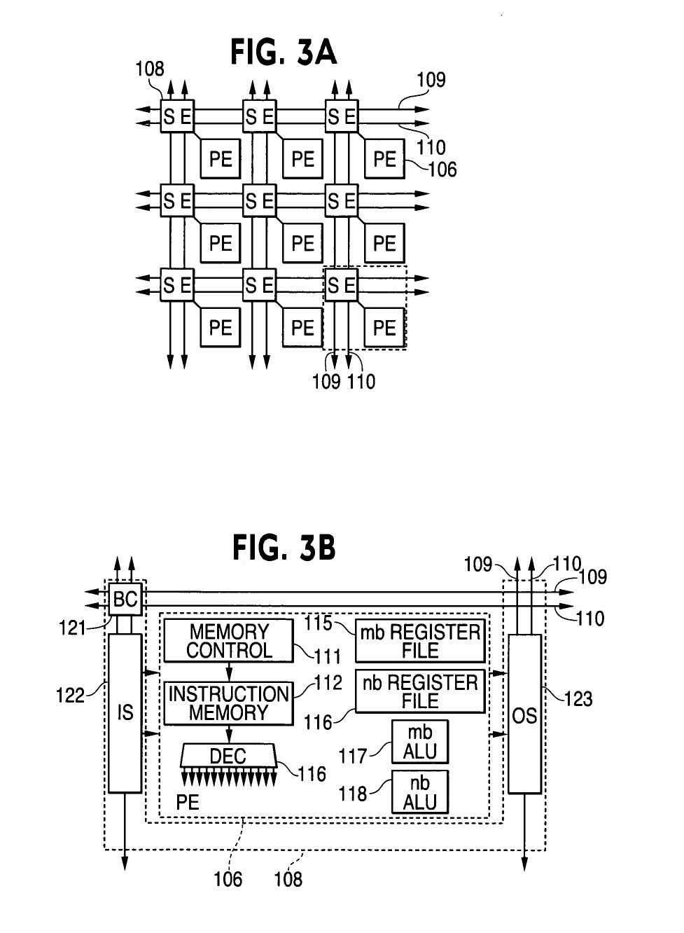

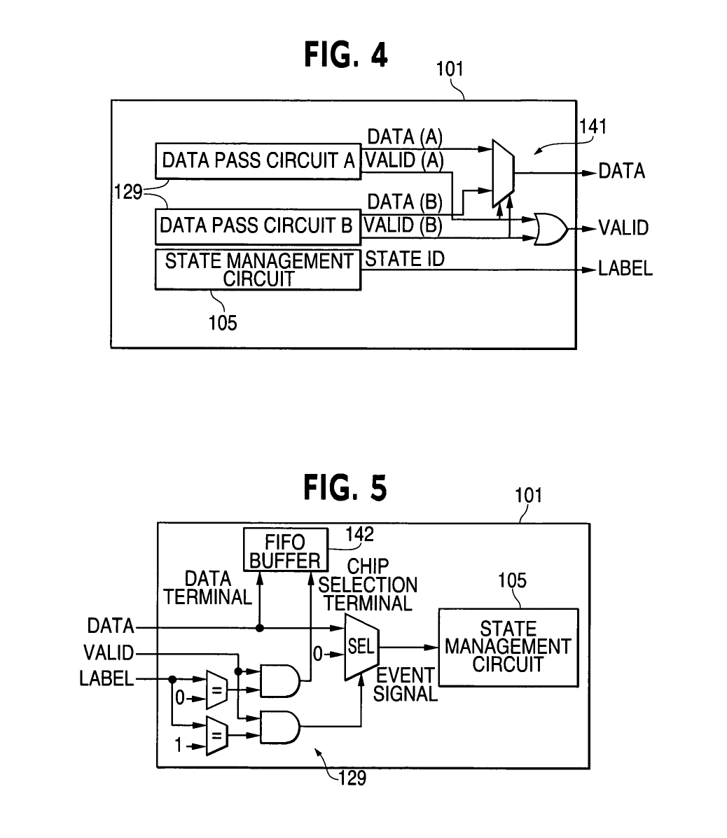

Thus, tasks are processed in each of a plurality of element areas 101 in accordance with object codes, and mutual data transfers involved in the plurality of tasks are intermediated by transfer intermediation circuits 102. In this event, a plurality of processor elements 106 and a plurality of switch elements 108 in element area 101 are combined in accordance with object codes to make up data pass circuit 129 which serves to be processing executing means to arbitrarily execute application and delivery of transfer data, as illustrated in FIGS. 4 and 5.

More specifically, as illustrated in FIG. 4, element area 101 delivers transfer data from data pass circuit 129 made up of a plurality of processor elements 106 to adjacent transfer intermediation circuit 102 in a predetermined operating state, and state management circuit 105, which serves to be transfer assigning means, delivers a state ID of that operation sate to transfer intermediation circuit 102 as a transfer ID (Label signal).

The transfer ID, delivered by element area 101 together with transfer data as described above, corresponds to final destination element area 101. In other words, a source transfer ID and a destination transfer ID of transfer data are in a one-to-one correspondence relationship, and the transfer ID is sequentially changed on a transfer route in accordance with the one-to-one correspondence, so that transfer data assigned a desired transfer ID is transferred to a desired destination.

Even when a task is processed in a certain element area 101, a transfer ID for transmission does not relate to a transfer ID for reception, so that a single transfer ID can be used to execute data transfer and data reception.

When a plurality of data pass circuits 129 deliver transfer data and a valid signal in parallel in a predetermined operating state, the transfer data and valid signal are preferably selected by logic circuit 141 such as a multiplexer. Such logic circuit 414 may be implemented in hardware, or may be dynamically made up of processor element 106 and switch element 108 in accordance with object codes in a manner similar to data pass circuit 129.

The foregoing transfer ID is defined in an arbitrary number of bits corresponding to the number of transfer routes through which transfer data is sent, but in array processor 100 of this embodiment, data pass circuit 129 of element area 101 delivers up to four types (=2²) of transfer data per task, and state management circuit 105 of element area 101 assigns one of four (=2²) 2-bit transfer IDs to the transfer data.

However, since this transfer ID is a state ID which is generated by state management circuit 105 in a predetermined operating state, state management circuit 105 manages up to four operating states per task in array processor 100 of this embodiment.

Since a plurality of element areas 101 individually execute data processing without establishing synchronization to one another, data pass circuit 129 makes the valid signal active for indicating that associated transfer data is valid only when transfer intermediation circuit 102 is applied with transfer data of the next stage, as described above.

While element area 101 generates a variety of data having an arbitrary number of bits, which involves a transfer for each task, the processed data having an arbitrary number of bits is divided into a plurality of transfer data having a predetermined number of bits which are then delivered. For example, when a processing unit per operation cycle of element area 101 is set to 32 bits, element area 101 can deliver 32-bit transfer data per operation cycle, while transfer intermediation circuit 102 can transfer 32-bit transfer data in parallel.

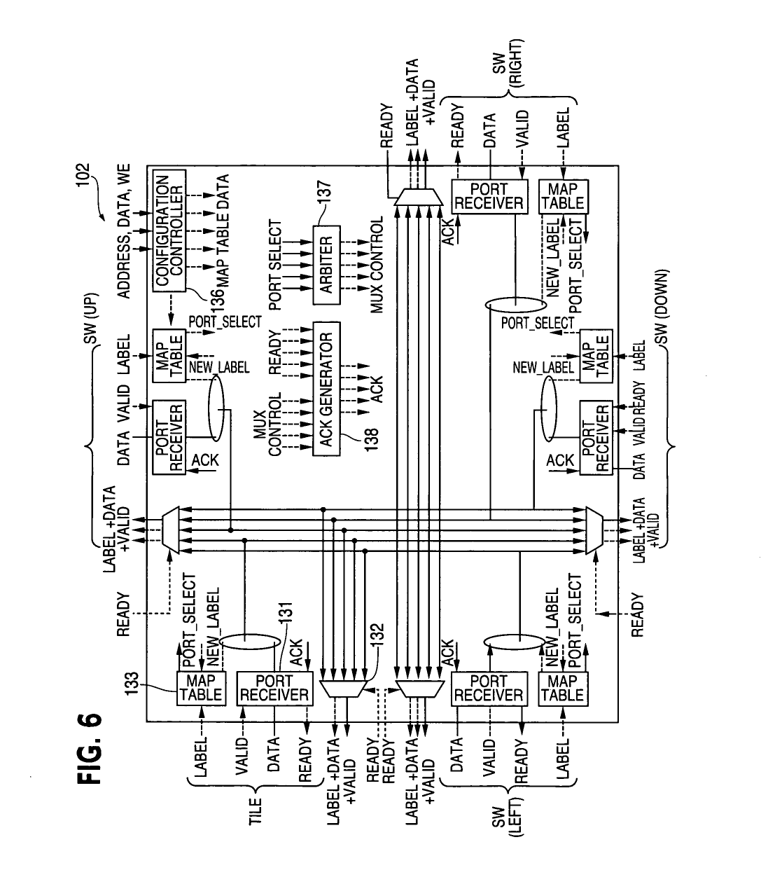

As illustrated in FIG. 6, transfer intermediation circuit 102 comprises five data reception ports 131; five data transmission ports 132; map table 133 which serves to be path storing means; configuration controller 136 which functions as part of data registering means; port arbiter 137 corresponding to data transfer control means; acknowledge generator 138; and the like.

As described above, in array processor 100 of this embodiment, a plurality of element areas 101, each of which is formed in a rectangular shape, are arranged in a matrix, and a plurality of transfer intermediation circuits 102 are connected one by one to the plurality of element areas 101. Then, since transfer intermediation circuit 102 is connected to four surrounding transfer intermediation circuits 102 positioned in the row and column directions and adjacent element area 101, transfer intermediation circuit 102 has five data reception ports 131 and five data transmission ports 132.

Data reception ports 131 of transfer intermediation circuit 102 individually receive transfer data together with a transfer ID from adjacent element area 101 or surrounding transfer intermediation circuits 102, while five data transmission ports 132 individually transmit transfer data together with a transfer ID to surrounding transfer intermediation circuits 12 or to adjacent element areas 101.

Map table 133 is formed for each data reception port 131, and variably stores combinations of a plurality of data transmission ports 132 with a plurality of types of transfer IDs for each of combinations of a plurality of data reception ports 132 with a plurality of types of transfer IDs. Since there are five each of data reception ports 131 and data transmission ports 132 as mentioned above, their port IDs are stored in three bits. Also, since there are four types of transfer IDs, the transfer IDs are stored in two bits.

Port arbiter 137 controls the operation of data transmission ports 132 with its output signal to transmit transfer data received at data reception port 131 together with its transfer ID from predetermined data transmission port 132 together with the transfer ID of the next stage, in accordance with data stored in map table 133.

Assuming, for example, that a combination of third data transmission port 132 with a transfer ID “11” has been registered for a combination of first data reception port 131 with a transfer ID “11,” when transfer data assigned a transfer ID “01” is received at first data reception port 131, this transfer data is transmitted from third data transmission port 132 with its transfer ID changed to “11.”

Since transfer data is also given a valid signal as mentioned above, data reception port 131 receives transfer data only when the valid data is active, and temporarily holds the transfer data in a storage circuit (not shown) such as a buffer circuit, a register and the like, and data transmission port 132 makes the valid signal active only when transfer data is transmitted.

Such a storage circuit can be mounted in data transmission port 132, rather than in data reception port 131, or may be mounted in both data reception port 131 and data transmission port 132.

Port arbiter 137 solves contentions of a plurality of transfer data by an existing approach, for example, a round robin method or the like when a plurality of transfer data concentrate on single data transmission port 132.

As configuration controller 136 is supplied with combinations of a plurality of data transmission ports 132 with a plurality of types of transfer IDs for each of combinations of a plurality of data reception port 131 with a plurality of types of transfer IDs from configuration management circuit 10, which serves to be data registering means, configuration controller 136 stores the combinations in map table 133.

Specifically, when array processor 100 operates in accordance with object codes as mentioned above, a task is set for each element area 101 by state management circuit 105, and control data corresponding to a mutual data transfer of the tasks is set for each transfer intermediation circuit 102 by configuration management circuit 103.

Acknowledge generator 138 relies on a ready signal delivered from connected data reception port 131 to determine whether or not this data reception port 131 can receive data, and supplies an active acknowledge signal to data reception port 131 which can receive data.

Acknowledge generator 138 does not make the acknowledge signal active when connected data reception port 131 does not supply the active ready signal, or when acknowledge generator 138 fails to acquire a transmission right by arbitration made by port arbiter 137.

Data reception port 131 invalidates transfer data held therein when the acknowledge signal becomes active, and makes the ready signal active for notifying data transmission port 132, from which data is transferred, of whether or not data reception port 131 is available for receiving data. Also, when the acknowledge signal is not active, data reception port 131 continues to hold transfer data, and does not make the ready signal active.

Even in element area 101 which is finally applied with transfer data from transfer intermediation circuit 102, the transfer data is arbitrarily received by data pass circuit 129, which is made up of a plurality of processor elements 106 and a plurality of switch elements 109, in accordance with object codes, as illustrated in FIG. 5.

More specifically, transfer intermediation circuit 102 relies on the transfer ID associated with transfer data applied to element area 101 to set whether the transfer data is event data of state management circuit 105 or processed data of data pass circuit 129.

For example, a 2-bit transfer ID can represent “0,” “1,” “2,” “3,” as mentioned above, wherein element area 101 illustrated in FIG. 5 regards transfer data associated with the transfer ID set at “0” or “1” alone as being processed thereby, and does not regard transfer data associated with the transfer ID set at “2” or “3” as being processed thereby.

Thus, in element area 101 illustrated in FIG. 5, when the transfer ID is “0” or “1,” transfer data with an active valid signal applied from transfer intermediation circuit 102 is applied to state management circuit 105 and FIFO buffer 142 by data pass circuit 129 in accordance the transfer ID.

If element area 101 does not receive transfer data from transfer intermediation circuit 102, this transfer data is held in data reception port 131 of transfer intermediation circuit 102, so that this data reception port 131 cannot receive transfer data at the next stage, resulting in sequential congestion of transfer data. To prevent this congestion, when element area 101 is requested by transfer intermediation circuit 102 to receive data, element area 101 receives the data even if the transfer data is not necessary.

The object codes for use with array processor 100 of this embodiment can be automatically generated from source codes by a data processing apparatus (not shown), as disclosed in JP-2003-99409-A by the applicant.

More specifically, such a data processing apparatus, which has previously been registered with constraints imposed by the physical structure and physical characteristics of array processor 100, interprets a sequence of source codes described in C-language or the like to generate DFG data, and generates, from this DFG, CDFG which schedules a plurality of operating states to which array processor 100 sequentially transitions in accordance with predetermined constraints.

From this CDFG, the data processing apparatus generates an RTL description of operating states at a plurality of stages, which is separated into a data path corresponding to processors/switch elements 106, 108 of array processor 100, and a finite state machine corresponding to state management circuit 105 in accordance with predetermined constraints, and generates from this RTL description a net list for processor elements 106 for each of the operating states at the plurality of stages in accordance with predetermined constraints for every mb/nb circuit resource such as mb ALU 117, nb ALU 118.

The RTL description of state management circuit 105 is converted to corresponding object codes, corresponding to the net list, and the net lists generated for processors/switch elements 106, 108 for each of the operating states at the plurality of stages are assigned to a plurality of processor elements 106 arranged in a matrix for each context of a plurality of cycles.

The net list assigned to processor element 106 is converted to corresponding object codes, and the net list assigned to switch element 108 is converted to object codes corresponding to the converted object codes of processor element 106.

In array processor 100 of this embodiment, however, tasks are independently processed in each of a plurality of element areas 101, as described above, and mutual data transfers associated with the tasks are performed by transfer intermediation circuit 102, so that the object codes must be generated from the source codes to realize the foregoing operations.

In this event, when a net list is generated from the source codes for each of a plurality of tasks, a transfer relationship described by “Send” and “Receive” functions indicative of data transmission/reception is generated as transfer information for each task. The generation of the transfer relationship as transfer information can be accomplished by a variety of descriptions of source codes indicative of data transmission/reception.

Next, the transfer information for a plurality of tasks is matched to generate a transfer route which entails a minimum total transfer cost, and an arrangement of the tasks. In this way, table information of the generated transfer route is integrated into the aforementioned net list, followed by generation of object codes as described above.

Consequently, object codes are generated for array processor 100 for independently processing the tasks for each of a plurality of element areas 101, and realizing mutual data transfers associated with the tasks by transfer intermediation circuit 102.

[Operation of Embodiment]

In the configuration as described above, array processor 100 of this embodiment processes data applied thereto from the outside in accordance with object codes supplied from the outside. In this event, state management circuit 105 sequentially changes from one operating state to another for each of a plurality of element areas 101, and sequentially switches contexts of processor elements 106 for each operation cycle.

Thus, multiple processor elements 106 individually operate in parallel to process data, wherein settings can be freely made by respective processor elements 106, and multiple switch elements 108 control and switch the connection relationships of multiple processor elements 106.

In this event, the results of processing in processor elements 106 are fed back to state management circuit 105, if necessary, as event data for each element area 101, so that state management circuit 105 relies on the event data applied thereto to change one operating state to the next and to switch the context of processor element 106 to the next context.

As described above, in array processor 100 of this embodiment, state management circuit 105 switches the contexts of processor element 106 for each of a plurality of element areas 101 to execute data processing involved in a plurality of tasks in parallel. In this event, as illustrated in FIG. 1B, the plurality of data processing sessions may require mutual transfers of processed data.

In this event, when tasks are registered in a plurality of element areas 101 in accordance with object codes, configuration management circuit 103 registers combinations of data transmission ports 132 with transfer IDs in map tables 133 of a plurality of transfer intermediation circuits 102, corresponding to the data transfer, for each of combinations of data reception ports 131 and transfer IDs.

In such a state, when element area 101 delivers transfer data together with a transfer ID (Label signal) to data reception port 131 of adjacent transfer intermediation circuit 102, this transfer intermediation circuit 102 changes the transfer ID corresponding to data stored in map table 133, and transmits the transfer data together with the changed transfer ID from predetermined data transfer port 132.

Thus, the transfer data delivered from element area 101 to adjacent transfer intermediation circuit 102 together with the transfer ID is transferred to target element area 101 by arbitrary transfer intermediation circuit 102.

[Advantages of Embodiments]

As described above, in array processor 100 of this embodiment, predetermined data corresponding to transfer routes is registered in map tables 133 of a plurality of transfer intermediation circuits 102, so that transfer data delivered by a plurality of element areas 101 together with a transfer ID can be reliably transferred to target element area 101.

Moreover, since the transfer ID can be generated in a number of bits corresponding to the number of transfer routes, the transfer ID can be generated in two bits, for example, when only four transfer routes must be ensured for each element area 101. Thus, array processor 100 of this embodiment eliminates the need for generating a long header and adding the header to transfer data, and can relatively improve the transfer efficiency even when a short length of data is transferred.

Particularly, while element area 101 delivers transfer data when it is in a predetermined operating state, a state ID indicative of this operating state is used as the transfer ID, so that a transfer ID corresponding to a particular operating state can be generated without the need for dedicated processing operation, and element area 101 can be burdened with reduced processing.

Moreover, element area 101 generates a variety of data which involve a transfer in an arbitrary number of bits on a task-by-task basis, and the processed data having an arbitrary number of bits is delivered in processing units for each operating cycle in element area 101. Therefore, element area 101 can simply generate transfer data which can be readily processed in various ways without the need for a dedicated processing operation for dividing processed data into a plurality of short transfer data.

Also, since transfer intermediation circuit 102 is connected to four surrounding transfer intermediation circuits 102, positioned in the row and column directions, and adjacent element area 101 through five data reception/transmission ports 131, 132, respectively, port IDs are stored in map table 133 in three bits.

Thus, map table 133 can store combinations of five data transmission ports 132 with four transfer IDs for each of combinations of five data reception ports 131 and four transfer IDs in ten bits ((2+3)×2=10), so that map table 133 can be formed by a circuit in an extremely small scale.

Further, when tasks are set in a plurality of element areas 101 in accordance with object codes, control data associated with the tasks are registered in map table 133 by configuration management circuit 103, so that data can be simply and exactly transferred for each of switchable tasks.

Element area 101 and transfer intermediation circuit 102 generate an active valid signal only when they deliver new transfer data, and element area 101 and transfer intermediation circuit 102 receive data transferred thereto only when the valid signal applied thereto is active. Further, element area 101 and transfer intermediation circuit 102 do not make the ready signal active when they cannot receive data transferred thereto, and element area 101 and transfer intermediation circuit 102 transmit transfer data only when the ready signal applied thereto is active.

Moreover, even if a plurality of transfer data concentrate on single data transmission port 132 within transfer intermediation circuit 102, contentions are solved by port arbiter 137. Thus, array processor 100 of this embodiment can highly efficiently transfer data even if a plurality of element areas 101 are out of synchronization in their data processing, or even if a plurality of transfer intermediation circuits 102 are out of synchronization in their data transfers. Consequently, a plurality of element areas 101 can also individually process tasks completely independently of one another without the need for integrally controlling the operation of a plurality of element areas 101, and.

Further, since transfer intermediation circuit 102 limits the type of data transferred thereby, a certain transfer bandwidth can be ensured at minimum for transfer data passing through transfer intermediate circuit 102. For example, when the transfer ID has two bits as mentioned above, four types of transfer data at maximum pass through single data reception port 131 of transfer intermediation circuit 102. Therefore, when a transfer route provides a transfer rate of “8 gigabits/sec,” a transfer rate of “2 gigabits/sec” is ensured for each transfer ID.

Also, since array processor 100 of this embodiment has state management circuit 105, which has the same width as one row, mounted halfway between the second and third rows of processor elements 106 arranged in four rows and four columns on element area 101, state management circuit 105 on element area 101 is connected to processor elements 106 arranged in four rows and four columns by respective minimum distances.

Moreover, configuration management circuit 103, which has the same width as one row, is mounted halfway between the second and third rows of element areas 101 arranged in four rows and four columns through transfer intermediation circuit 102 in the row direction, and this single configuration management circuit 103 is connected to multiple transfer intermediation circuits 102 by respective minimum distances, thus permitting array processor 100 to operate at high speeds without waste.

[Exemplary Modifications to Embodiment]

The present invention is not limited to the embodiment described above, but can be modified without departing from the spirit and scope of the invention. For example, while the foregoing embodiment has specifically described the number, arrangement, and the like of element areas 101 and processor elements 106 by way of example, the number, arrangement and the like can be changed as appropriate, as a matter of course.

For example, the foregoing embodiment has illustrated that state management circuit 105, which has the same width as one row, is mounted halfway between the second and third rows of processor elements 106 arranged in four rows and four columns on element area 101, and configuration management circuit 103, which has the same width as one row, is mounted halfway between the second and third rows of element areas 101 arranged in four rows and four columns through transfer intermediation circuit 102 in the row direction. State management circuit 105 and configuration management circuit 103 can be modified in shape and arrangement as well in various ways.

For example, while the foregoing embodiment has illustrated that element area 101 is formed in a rectangular shape which is optimal for a matrix layout, element area 101 can be formed in a shape other than the rectangular shape, and can be laid out in a triangular or a hexagonal shape (not shown).

While the foregoing embodiment has illustrated that transfer intermediation circuits 102 are positioned in lines within respective gaps in the row direction between element areas 101 arranged in a matrix shape, each transfer intermediation circuit 102 may be formed in an L-shape opposing the left side and bottom side of element area 101, or in a cross shape to be positioned at the center of a matrix of four element areas 101 (not shown).

Also, while the foregoing embodiment has specifically illustrated the internal configuration of processor element 106 and switch element 108, these elements can be implemented in various configurations. For example, processor element 106 illustrated above has mb and nb register files 115, 116 and nb and mb ALUs 117, 118, but processor element 106 may only have mb register file 115 and mb ALU 117. In addition, mb and nb ALUs 117,118 can be replaced with a processing circuit which is capable of supporting composite processing, or with a large-scaled processing circuit which is capable of supporting large-scaled processing at a task level.

Further, while the foregoing embodiment has illustrated that transfer intermediate circuit 102 transfers data in parallel, data can be transferred in series by connecting a serial-to-parallel converter to data reception port 131 of transfer intermediation circuit 102, and connecting a parallel-to-serial converter to data transmission port 132.

Also, while the foregoing embodiment has illustrated, as a parallel processing apparatus, array processor 100 which has state management circuit 105 completely separated from processor elements 106 and switch elements 108, array processor 100 can have state management circuit 105 integrally formed with processor elements 106 and the like, for example, as so-called FPGA (not shown).

Further, while the foregoing embodiment has illustrated that state management circuits 105 are provided one for a plurality of element areas 101 such that the plurality of element areas 101 independently execute processing operations, state management circuits 105 each associated with a plurality of element areas 101 can be integrally controlled by a single central management circuit (not shown).

Also, while the foregoing embodiment has illustrated array processor 100 alone, a processing apparatus or a semiconductor integrated circuit (not shown) having such array processor 100 can be implemented, in which case array processor 100 is applied with data for processing and offers the processed data. A computing apparatus (not shown) can also be implemented for executing a variety of data processing with such a semiconductor integrated circuit.

While general semiconductor integrated circuits such as ASIC (Application Specific Integrated Circuit) cannot be modified in circuit configuration after they have been manufactured, a semiconductor integrated circuit or a processing apparatus which is equipped with array processor 100 can be modified in circuit configuration even after the manufacturing. Thus, troubles, if any, can be corrected even after the manufacturing of the semiconductor integrated circuit and the like, thereby making it possible to eliminate design changes and the like to largely reduce the cost from development to mass production of a semiconductor circuit and the like.

Similarly, a computing apparatus equipped with such a semiconductor integrated circuit can correct defects or modify circuit operations by changing software without exchanging the semiconductor integrated circuit, thus making it possible to improve the usability.

Also, while the foregoing embodiment has specifically illustrated the circuit configuration built within element area 101 which delivers transfer data, and element area 101 which receives transfer data, as illustrated in FIGS. 4 and 5, the internal configuration of element area 101 can be built in various ways, as a matter of course.

For example, while FIG. 4 illustrates the configuration of single element area 101 which is formed with two data pass circuits 129, element area 101 may be formed with one or three or more data pass circuits 129, or a plurality of data pass circuits 129 may reside in a separate context.

Further, while the foregoing embodiment has illustrated that single state management circuit 105 resides in one element area 101, a plurality of state management circuits 105 may reside in one element area 101.

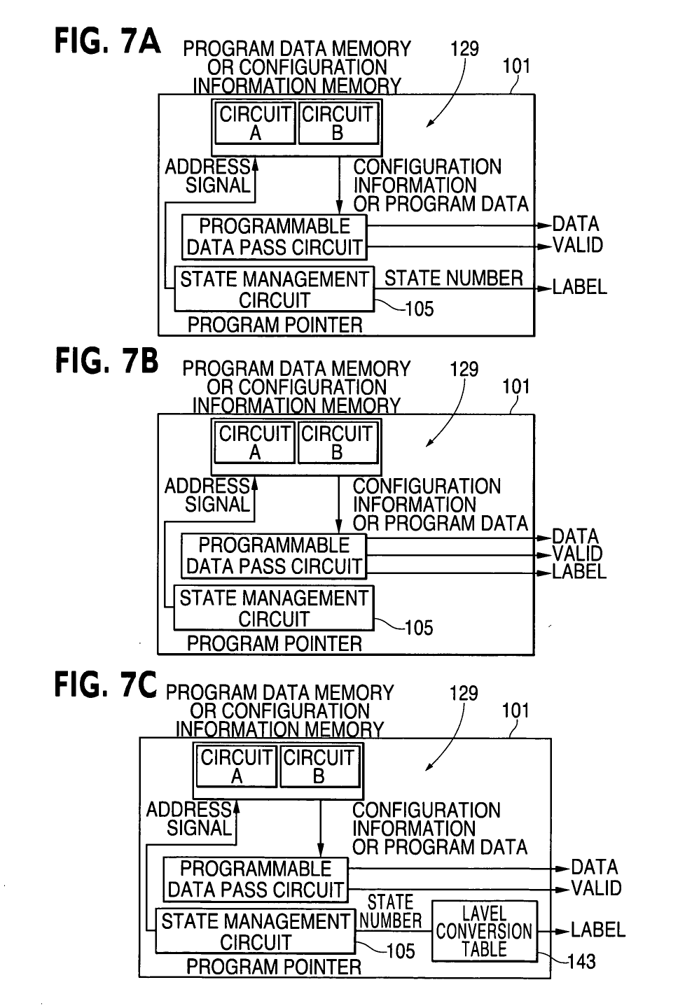

The foregoing embodiment has illustrated that when transfer data, valid signal, and the like are delivered in parallel while a plurality of data pass circuits 129 in element area 101 remain in a predetermined operating state, a plurality of transfer data and the like are selected by logic circuit 141. However, if transfer data and the like are delivered from only one of a plurality of data pass circuits 129 for one operating state of element area 101, a logic circuit for selecting the transfer data and the like can be omitted from element area 101, as illustrated in FIG. 7A.

Further, while the foregoing embodiment has illustrated that the state ID of the state management circuit 105 is utilized as a transfer ID which is generated when element area 101 is in a predetermined operating state, such utilization of the state ID will limit the number of transfer routes to the number of operating states at maximum, and cannot either correspond a plurality of transfer routes to one operating state.

Therefore, if the foregoing inconveniences cause a problem, it is preferable that a dedicated transfer ID is generated by data pass circuit 129, or that data pass circuit 129 adds an identification bit to the state ID to generate a transfer ID (not shown), as illustrated in FIG. 7B.

When it is not appropriate that the state ID is utilized as the transfer ID, the state ID is preferably converted to the transfer ID by ID converter circuit 143, as illustrated in FIG. 7C. Such ID converter circuit 143 can be formed by dedicated hardware, or may be made up of processor element 106 and switch element 108 as a data pass circuit.

Further, while the foregoing embodiment has illustrated that the transfer ID is externally added to. transfer data, the transfer ID can be internally inserted as part of such transfer data. In such a data structure, the transfer ID can be changed by transfer intermediation circuit 102 by partially or fully rewriting the transfer data.

A plurality of transfer data can be transferred with a single transfer ID, in which case the transfer ID can be externally added to the plurality of transfer data, or the transfer ID can be internally inserted into one of the plurality of transfer data.

Further, while the foregoing embodiment has illustrated that a transition of the operating state simply corresponds one-to-one to the switching of context for simplifying the description, the operating state may not correspond one-to-one to the context, or the context may be maintained though the operating state transitions, by way of example. Also, when a circuit, the operating state of which is forced to transition, is built on element area 101 or the like by object codes, the context is maintained even when the circuit transitions from one operating state to another.

While the foregoing embodiment has illustrated that the state transition and context switching are executed in flux by event data, the order of the state transition and context switching, for example, can be fixedly set beforehand.

Further, while the foregoing embodiment has been described on the assumption that array processor 100 is formed as one integrated circuit, a plurality of element areas 101 and a plurality of transfer intermediation circuits 102, for example, may be formed as respective independent integrated circuits, such that they are connected to form array processor 100.

While preferred embodiments of the present invention have been described using specific terms, such description is for illustrative purposes only, and it is to be understood that changes and variations may be made without departing from the spirit or scope of the following claims.

1. A parallel processing apparatus having a plurality of variable processing circuits arranged in a predetermined layout together with a plurality of transfer intermediation circuits, wherein each said variable processing circuit variably executes a variety of processing, and each said transfer intermediation circuit intermediates a mutual data transfer between said variable processing circuits, wherein:
each said variable processing circuit comprises:
processing executing means for arbitrarily receiving and delivering transfer data by each of said variety of processing; and
transfer assigning means for assigning one of a plurality of types of transfer IDs (identities) to transfer data delivered to said transfer intermediation circuit corresponding to said variable processing circuit which is a final destination, and
each said transfer intermediation circuit comprises:
a plurality of data reception ports for individually receiving the transfer data together with the transfer ID from said variable processing circuits therearound or said transfer intermediation circuit;
a plurality of transmission ports for individually transmitting said transfer data together with the transfer ID to said variable processing circuits therearound or said transfer intermediation circuit;
route storing means for variably storing combinations of said plurality of data transmission ports with said plurality of types of transfer IDs for each of combinations of said plurality of data reception ports with said plurality of types of transfer IDs; and
transfer control means for transmitting the transfer data received at one of said data reception ports together with the transfer ID to a predetermined one of said data transmission ports together with the transfer ID of the next stage in accordance with data stored in said route storage means.

2. The parallel processing apparatus according to claim 1, further comprising:
data registering means for registering combinations of said plurality of data transmission ports with said plurality of types of transfer IDs for each of combinations of said plurality of data reception ports with said plurality of types of transfer IDs in said route storing means of each of said plurality of transfer intermediation circuits.

3. The parallel processing apparatus according to claim 1, wherein:
said processing executing means of said variable processing circuit delivers up to 2ⁿ of the transfer data; and
said transfer assigning means of said variable processing circuit assigns one of 2ⁿ types of the transfer IDs having n bits to the transfer data.

4. The parallel processing apparatus according to claim 1, wherein:
said plurality of variable processing circuits are each formed in a rectangular shape, and are arranged in a matrix shape;
said plurality of transfer intermediation circuits are placed one by one adjacent to said plurality of variable processing circuits;
each said transfer intermediation circuit includes five of said data reception ports and five of said data transmission ports for communicating individually with four surrounding ones of said transfer intermediation circuits positioned in row and column directions and an adjacent one of said variable processing circuits; and
said route storing means of said transfer intermediation circuit individually stores said five data reception ports and said five data transmission ports, as represented by 3-bit port IDs.

5. The parallel processing apparatus according to claim 1, wherein said processing executing means of said variable processing circuit divides processed data having an arbitrary number of bits into a plurality of the transfer data having a predetermined number of bits, and delivers the divided transfer data.

6. The parallel processing apparatus according to claim 1, wherein:
said processing executing means of said variable processing circuit sequentially makes a transition from one to another of a plurality of operating states every operation cycle, and accepts the transfer data assigned a predetermined one of the transfer ID when in a predetermined operating state.

7. The parallel processing apparatus according to claim 1, wherein said variable processing circuit includes:
a plurality of data processing circuits each for executing data processing in response to an individually set operation instruction; and
a plurality of wire switching circuits each for controlling a connection relationship between said plurality of data processing circuits in response to an individually set operation instruction,
said plurality of data processing circuits and said plurality of wire switching circuits being arranged in a matrix.

8. The parallel processing apparatus according to claim 7, wherein:
said variable processing circuit further comprises a state management circuit for sequentially switching operation instructions for said data processing circuits and said wire switching circuits to sequentially make a transition from one to another of a plurality of operating states every operation cycle.

9. The parallel processing apparatus according to claim 7, wherein said variable processing circuit delivers the transfer data and the transfer ID from at least part of said plurality of data processing circuits upon receipt of a predetermined one of the operation instructions.

10. The parallel processing apparatus according to claim 8, wherein said variable processing circuit, when in the predetermined operating state, delivers the transfer data from at least part of said plurality of data processing circuits and delivers a state ID associated with said operating state from said state management circuit as the transfer ID.

11. A processing apparatus having a processing circuit for executing a processing operation in accordance with object codes, said processing circuit being applied with data for processing to offer processed data, wherein:
said processing circuit comprises the parallel processing apparatus according to claim 1.

12. A semiconductor integrated circuit having a processing circuit for executing a processing operation in accordance with object codes, said processing circuit being applied with data for processing to offer processed data, wherein:
said processing circuit comprises the parallel processing apparatus according to claim 1.

13. A computing apparatus for executing a variety of data processing with a semiconductor integrated circuit, comprising:
the semiconductor integrated circuit according to claim 12.

14. A data processing method for generating object codes from source codes of the parallel processing apparatus according to claim 1, said method comprising the steps of:
previously registering constraints associated with a physical configuration and physical characteristics of said parallel processing apparatus;
linguistically analyzing a sequence of said source codes to generate a data flow graph (DFG);
generating a control data flow graph (CDFG) from said DFG, said CDFG scheduling operating states at a plurality of stages through which said parallel processing apparatus sequentially transitions in accordance with a predetermined one of the constraints;
generating a register transfer level (RTL) description of the operating states in accordance with a predetermined one of the constraints from the CDFG;
generating net list data for each of the operating states in accordance with a predetermined one of the constraints from the RTL description; and
converting the RTL description to the object codes corresponding thereto in accordance with the net list; and
converting the net list generated for each of the operating states to the object codes,
wherein said method further comprising the steps of:
generating a transfer relationship of transfer data for a plurality of tasks as transfer information when generating said net list from said source codes;
matching the transfer information for said plurality of tasks to generate a transfer route and placement of the tasks which minimize a total transfer cost; and
integrating table information of the generated transfer route into said net list.

15. A data processing apparatus for generating object codes from source codes of the parallel processing apparatus according to claim 1, wherein:
said data processing apparatus previously registers constraints associated with a physical configuration and physical characteristics of said parallel processing apparatus, linguistically analyzes a sequence of said source codes to generate a DFG, generates a CDFG from said DFG, said CDFG scheduling operating states at a plurality of stages through which said parallel processing apparatus sequentially transitions in accordance with a predetermined one of the constraints, generates an RTL description of the operating states in accordance with a predetermined one of the constraints from the CDFG, generates net list data for each of the operating states in accordance with a predetermined one of the constraints from the RTL description, converts the RTL description to the object codes corresponding thereto in accordance with the net list, and converts the net list generated for each of the operating states to the object codes, said data processing apparatus comprising:
transfer generating means for generating a transfer relationship of transfer data for a plurality of tasks as transfer information when generating said net list from said source codes;
placement generating means for matching the transfer information for said plurality of tasks to generate a transfer route and placement of the tasks which minimize a total transfer cost; and
data integrating means for integrating table information of the generated transfer route into said net list.

16. Object codes for the parallel processing apparatus according to claim 1, wherein:
said object codes are generated by the data processing method according to claim 14 in association with a transfer route and placement of tasks which minimize a total transfer cost.
